(19) United States
(12) Patent Application Publication
(10) Pub. No.: US 2019/0147046 A1
(43) Pub. Date: May 16, 2019

(54) SYSTEMS AND METHODS FOR PROVIDING PERSONALIZED CONTEXT-AWARE INFORMATION

(71) Applicant: Facebook, Inc., Menlo Park, CA (US)

(72) Inventors: Eric Deng, Fremont, CA (US); Andrew Gold, Los Altos, CA (US)

(21) Appl. No.: 15/814,867

(22) Filed: Nov. 16, 2017

(51) Int. Cl. G06F 17/30; G06F 3/01; H04W 4/06; G06K 9/00

(52) U.S. Cl. CPC G06F 17/3005; G06F 17/30029; G06F 17/30038; G06K 9/00006; H04W 4/06; G06K 9/00288; G06F 3/011

(57) ABSTRACT

A computer-implemented method may include (1) capturing, by at least one sensor of an information portal device, sensor data in a vicinity of the information portal device, (2) identifying, by the information portal device and based on the sensor data, a person in the vicinity of the information portal device, (3) accessing, by a communication network interface of the information portal device, personally applicable information corresponding to the person that has been identified, (4) selecting, by at least one physical processor, a portion of the personally applicable information based on a current context associated with the person, and (5) presenting, by a user interface of the information portal device, the selected portion of the personally applicable information. Various other methods, systems, and computer-readable media are also disclosed.

### BACKGROUND

Not long ago, people depended upon printed information, such as maps, newspapers, books, and the like to gather information regarding a particular place, such as a nearby restaurant, a hotel in a distant town, and other areas or points of interest. In addition, people often relied on word-of-mouth directions or recommendations from friends or strangers to obtain such information. Even within a particularly limited area, such as a public building or a corporate enterprise site, a person typically would rely on signage or other printed material, as well as information provided by others nearby, to obtain information regarding a particular location (e.g., a meeting room, a dining hall, etc.).

With the advent of the World Wide Web, followed by the development of the smartphone, people with at least a baseline knowledge in these newer technologies now have fingertip access to a plethora of information of interest. To access such information, a user typically enters search terms or other input data specifying the type of information desired into a web browser, map application, or other software. Consequently, the accuracy of the information returned in response to such a user query, as well as the applicability and level of detail of that information, typically depends on the application employed, the database being queried, the skill of the user in selecting appropriate search terms, and the like.

### SUMMARY

As will be described in greater detail below, the instant disclosure describes systems and methods for providing personalized context-aware information to one or more individuals. In one example, a method for providing personalized context-aware information may include (1) capturing, by at least one sensor of an information portal device, sensor data in a vicinity of the information portal device, (2) identifying, by the information portal device and based on the sensor data, a person in the vicinity of the information portal device, (3) accessing, by a communication network interface of the information portal device, personally applicable information corresponding to the person that has been identified, (4) selecting, by at least one physical processor, a portion of the personally applicable information based on a current context associated with the person, and (5) presenting, by a user interface of the information portal device, the selected portion of the personally applicable information.

In some examples, the current context may include a current location of the person. The current context may also include a current time and/or a current location of the person.

In some embodiments, the personally applicable information may also be selected based on personal characteristic information corresponding to the person. This personal characteristic information corresponding to the person may include personal preference information corresponding to the person and/or personal historical information corresponding to the person.

In some examples, the method may further include detecting, by the information portal device, the person signaling to the information portal device. In these examples, the person may be identified in response to detecting the person signaling to the information portal device. In some examples, detecting the person signaling to the information portal device may include detecting a physical gesture performed by the person, an intentional movement by the person, a facial expression of the person, and/or physical contact by the person with the information portal device.

In one example, the method may further include travelling, by the information portal device prior to identifying the person, to a location. In these examples, the person may be identified at the location. In some examples, the method may further include selecting, prior to the travelling to the location, the location from multiple locations based on previous detected presences of multiple people at the multiple locations.

In some embodiments, the sensor may include (1) an optical sensor that captures optical data of at least a portion of the person, (2) a tactile sensor that captures a fingerprint image of the person, (3) an electronic information sensor that captures digital identification information corresponding to the person, and/or (4) an audio sensor that captures a voice of the person.

In one example, the personally applicable information may also be selected based on a current priority of the selected portion of the personally applicable information relative to a current priority of other portions of the personally applicable information. In some examples, the current priority of the portion of the personally applicable information may be based on a time value associated with the portion of the personally applicable information.

In some examples, a level of confidence may be associated with the identification of the person. In these examples, the selecting of the portion of the personally applicable information may be further based on the level of confidence. In some embodiments, identifying the person in the vicinity of the information portal device may include executing a plurality of identification algorithms, each identification algorithm within the plurality of algorithms may generate an associated level of confidence, and the level of confidence associated with identifying the person may be based on a combination of the associated levels of confidence. Moreover, in some examples, executing the plurality of identification algorithms may include (1) executing a first algorithm of the plurality of identification algorithms to generate an identification of the person and a first associated level of confidence, and (2) executing at least one additional algorithm of the plurality of identification algorithms in response to the first associated level of confidence falling below a threshold. In some examples, a relatively higher level of confidence may be associated with the selected portion of the personally applicable information containing relatively more sensitive information.

In some embodiments, the selected portion of the personally applicable information may include information provided by another person, and presenting the selected portion of the personally applicable information may use a representation of the other person.

In addition, a corresponding system for providing personalized context-aware information may include at least one sensor that captures sensor data in a vicinity of the system. The system may also include several modules stored in memory, including (1) an identification module that identifies, based on the sensor data, a person in the vicinity of the system, (2) an information access module that accesses personally applicable information corresponding to the person that has been identified, and (3) an information selection module that selects a portion of the personally applicable information based on a current context associated with the person. The system may also include a user interface that presents the selected portion of the personally applicable information, and at least one physical processor that executes the identification module, the information access module, and the information selection module.

In some examples, the above-described method may be encoded as computer-readable instructions on a computer-readable medium. For example, a computer-readable medium may include computer-executable instructions that, when executed by at least one processor of a computing device, may cause the computing device to (1) identify a person in a vicinity of the computing device based on sensor data captured in the vicinity of the computing device, (2) access personally applicable information corresponding to the person that has been identified, and (3) select a portion of the personally applicable information based on a current context associated with the person for presentation by a user interface of the computing device.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a flow diagram of an example method for providing personalized context-aware information.

FIG. 2 is a block diagram of an example system for providing personalized context-aware information.

FIG. 3 is a block diagram of another example system for providing personalized context-aware information.

FIGS. 4-7 are flow diagrams of example sub-methods for providing personalized context-aware information.

FIG. 8 is an illustration of an example information portal device for providing personalized context-aware information.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure is generally directed to providing personalized context-aware information. As will be explained in greater detail below, embodiments of the instant disclosure may include (1) capturing sensor data in the vicinity of an information portal device, (2) identifying, based on the sensor data, a person in the vicinity of the information portal device, (3) accessing, using a communication network interface associated with the information portal device, personally applicable information that corresponds to the identified person, (4) selecting a relevant portion of the personally applicable information to display based on a current context associated with the person, and then (5) presenting, via a user interface of the information portal device, the selected portion of the personally applicable information. By employing the identity of the person and the current context associated with that person, the disclosed systems and methods may provide information of current interest to the person without requiring the person to explicitly request the same, such as by way of entering one or more search terms. In addition, by reducing the amount of information required from the person to obtain desired information, the disclosed systems and methods may reduce the amount of information being transferred over a communication network between computing devices, thus rendering the operation of the overall system more efficient.

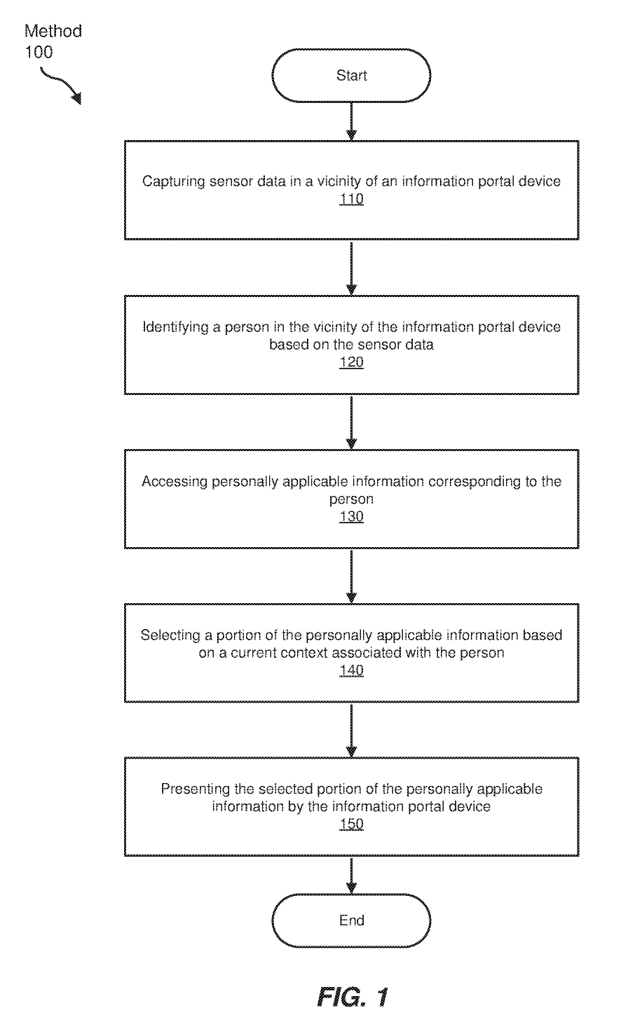

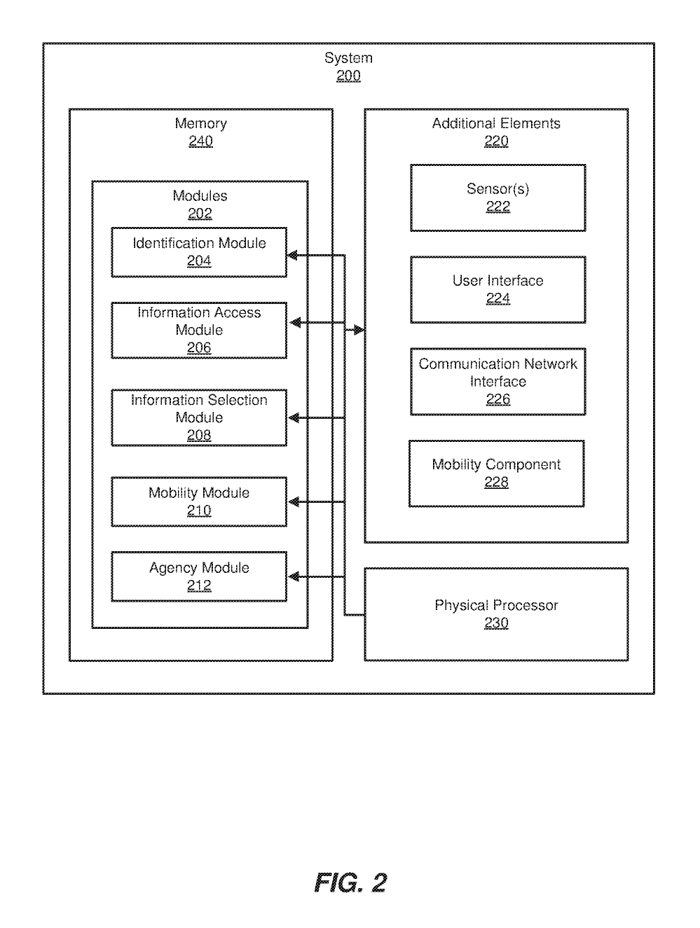

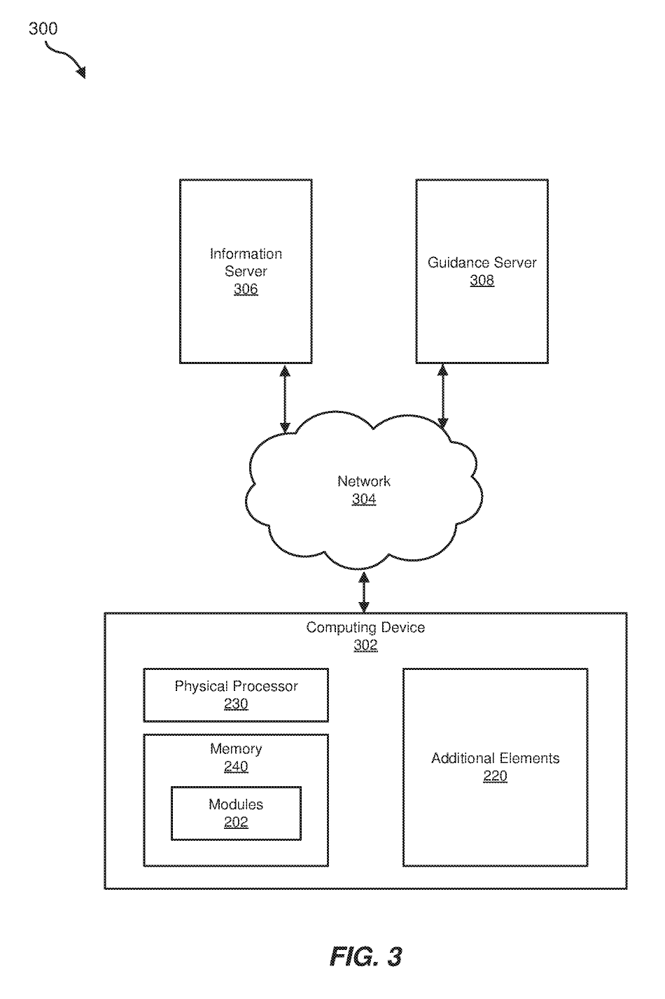

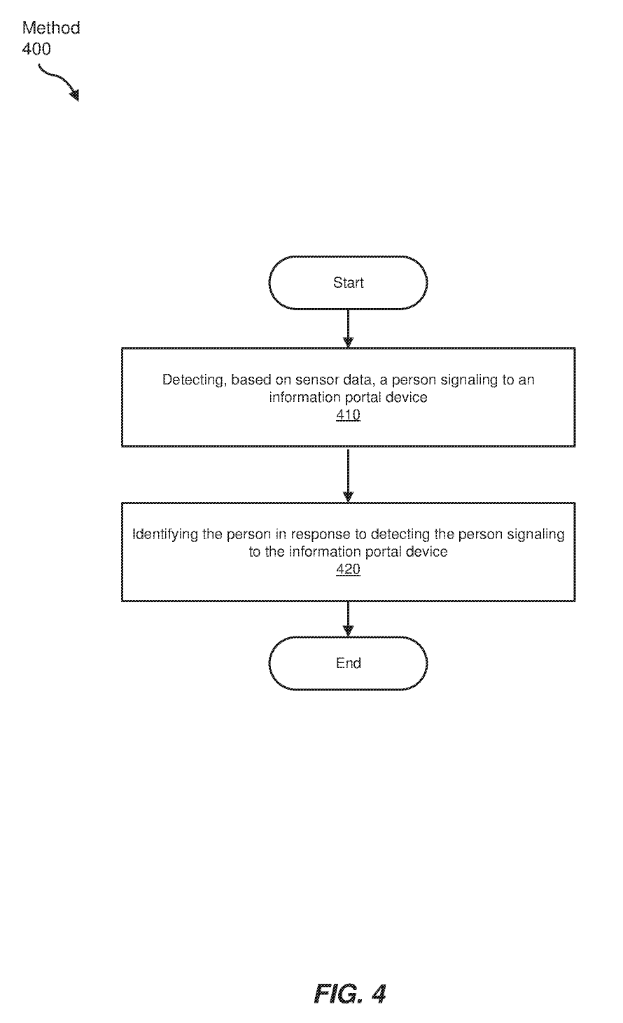

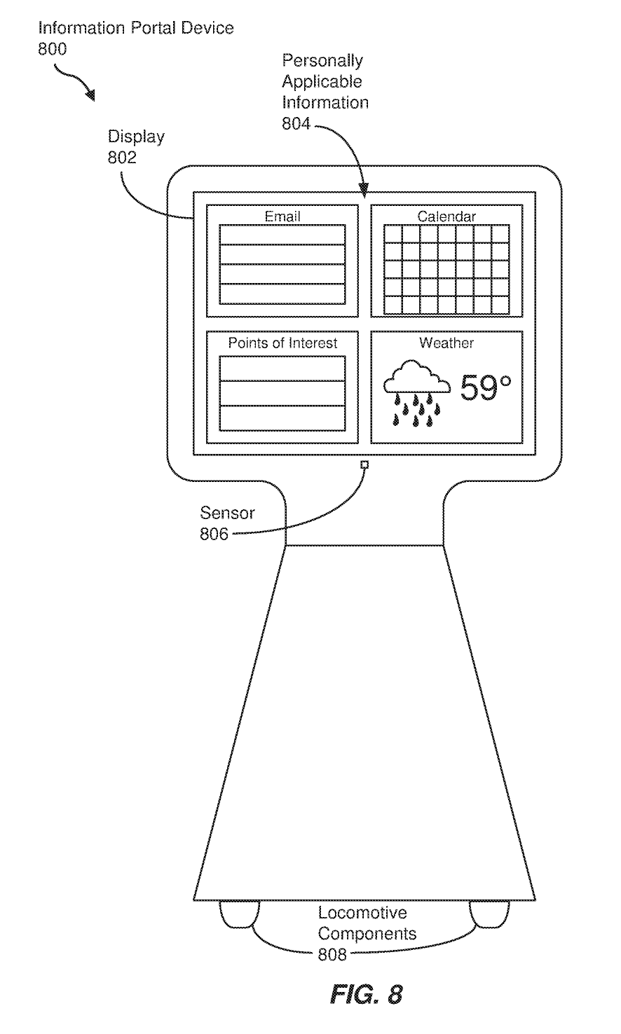

The following will provide, with reference to FIG. 1, an example method for providing personalized context-aware information. Detailed descriptions of example systems for providing personalized context-aware information will also be presented in conjunction with FIGS. 2 and 3. In addition, additional example sub-methods for providing personalized context-aware information will be discussed in connection with FIGS. 4 through 7. An example information portal device for providing personalized context-aware information is discussed in detail with respect to FIG. 8.

FIG. 1 is a flow diagram of an example computer-implemented method 100 for providing personalized context-aware information. The steps shown in FIG. 1 may be performed by any suitable computer-executable code and/or computing system, including the systems illustrated in FIGS. 2, 3, and 8. In one example, each of the steps shown in FIG. 1 may represent an algorithm whose structure includes and/or is represented by multiple sub-steps, examples of which will be provided in greater detail below. In some examples, a computing system characterized as an information portal device (such as information portal device 800 in FIG. 8) may be employed as a computing system performing example method 100 of FIG. 1.

As illustrated in FIG. 1, at step 110, one or more of the systems described herein may capture sensor data (e.g., generated by one or more sensors) in the vicinity of the system. The disclosed systems may capture any of a variety of forms of sensor data in any of a variety of forms and contexts. For example, the sensor data may be visual or optical data (e.g., generated by a camera or other image sensor (e.g., a retinal scanner or an optical fingerprint scanner), or another type of device capturing optical data, such as a three-dimensional (3D) optical sensor), touch or contact data (e.g., generated by a fingerprint scanner or other tactile or contact sensor capable of capturing physical attributes that uniquely identify an individual), audio data (e.g., generated by a microphone or other audio sensor), or electronic data (e.g., generated by a Radio Frequency Identification (RFID) scanner, BLUETOOTH transceiver, WIFI transceiver, electronic card reader, or the like). In some examples, the system may employ multiple sensors to capture multiple types of sensor data.

At step 120, the system may identify, based on the sensor data, a person in the vicinity of the system. The disclosed systems may identify persons in any of a variety of ways. For example, the system may apply (1) a facial recognition algorithm to optical or image sensor data to identify the person, (2) a fingerprint comparison algorithm to tactile sensor data to identify the person, and/or (3) a voice recognition algorithm to audio sensor data to identify the person. Additionally or alternatively, the system may compare electronic data, such as RFID data or other types of electronic data from an identification card (e.g., an enterprise identification badge with an RFID tag) or other electronic data-carrying device or unit, with electronic identification data to identify the person.

At step 130, the system may access personally applicable information corresponding to the identified person. The term “personally applicable information,” as used herein, generally refers to any type or form of information that may be specifically or uniquely identified with a person, such as email or voicemail messages addressed to the person, calendar items (e.g., scheduled meetings, planned events, and so on), tasks to be completed, and the like. In some examples, the personally applicable information may be information that is generally available to the public or some subset thereof, but may be of particular interest to the person, such as service locations (e.g., restaurants, lodging establishments, sports arenas, etc.) or more locally identified areas (e.g., meeting rooms, dining halls, restrooms, or other intrabuilding or intra-site locations), weather forecasts, and traffic conditions. As will be explained in greater detail below, the systems described herein may access personally applicable information in a variety of ways.

At step 140, the system may select a portion of the personally applicable information corresponding to the identified person based on a current context associated with that person. In some examples, the current context may be the current location of the person, the current time at the current location of that person, an activity in which the person is currently engaged (e.g., working, reading, exercising, resting, etc.), and/or another aspect or characteristic of the current environment of the person. In some examples, the current activity in which the person is engaged may be determined by calendar entries associated with that person, the current location of the person, the current detected use of a srnartphone by the person, and/or by the sensor data noted above. For example, if the current time is noon on a weekday, and the person is at his typical place of work, the selected portion of the personally applicable information may include information regarding a particular dining hall onsite, or information regarding nearby offsite restaurants (e.g., location, directions, menu, current waiting time, and so on).

In some example embodiments, the system may also base the selection of the personally applicable information on personal characteristic information corresponding to the person, which may be any information that describes some personal aspect or characteristic of the person. In some examples, the personal characteristic information may include personal preference information, which may include preferences of the person regarding the types of information in which the person is interested (e.g., particular types of cuisine, particular points of interest, particular sports teams, and so on). In other example embodiments, the personal characteristic information may include personal historical information, which may include prior interests, actions, and other aspects of the person (e.g., establishments visited, number of visits to the current environment (possibly indicating a level of familiarity with the current location), events attended, books read, movies or television shows viewed, positive or negative reviews of those establishments or items, educational background, work history, social network contacts, and the like). Also in some examples, the system may employ other types of personal characteristic information associated with the person to select the portion of the personally applicable information.

At step 150, the system (e.g., employing a user interface) may present the selected portion of the personally applicable information (e.g., to the person). The disclosed systems may present this information in any of a variety of ways, including visually (e.g., using two-dimensional and/or three-dimensional imagery) as well as audially.

FIG. 2 is a block diagram of an example system 200 for providing personalized context-aware information. As illustrated in this figure, example system 200 may include one or more modules 202 for performing one or more tasks. As will be explained in greater detail below, modules 202 may include an identification module 204, an information access module 206, and an information selection module 208. In some example examples, modules 202 may also include a mobility module 210 and/or an agency module 212. Although illustrated as separate elements, one or more of modules 202 in FIG. 2 may represent portions of a single module or application.

In the example embodiments described in greater detail below, system 200 may be employed as an information portal device that provides personalized context-aware information to one or more individuals. In some examples, several such systems 200 may be used to provide such information to individuals of a grc up.

Identification module 204 may identify a person in a vicinity of system 200 based on sensor data captured by one or more sensors 222 of system 200. As mentioned above, identification module 204 may employ facial recognition, voice recognition, tactile (e.g., fingerprint) comparison, and other algorithms to identify the person.

Information access module 206, in some examples, may access personally applicable information corresponding to the identified user. As indicated above, such information may be information that specifically or uniquely applies to the person and/or information that is generally available but still may be of particular interest to the person.

In some examples, information selection module 208 may select a portion of the personally applicable information based on a current context associated with the person, such as a current location of the person, a current time at the current location of the person, an activity in which the person is currently engaged, and/or another aspect or characteristic of the current environment of the person, as noted above.

Mobility module 210 may move system 200, or some portion thereof, within some environment, such as a building or campus of an enterprise or establishment, a sports arena, or any other indoor or outdoorvenue. Control of the movement of system 200 using mobility module 210 may originate with mobility module 210 itself, or by way of a server communicating with system 200. In some examples, mobility module 210 may cause system 200 to move to a location in which a relatively large number of people are expected to be (e.g., a lobby or large meeting room of a building) to increase overall engagement of system 200 with people to provide personalized context-aware information. The movement of system 200 may be performed by a mobility component 228, described below. Also in some examples, mobility module 210 may further provide assistance to one or more people, such as directing a person to a desired location (e.g., a meeting room, a restroom, etc.), retrieving one or more items for a person, and so on.

Agency module 212, in some examples, may cause system 200 to operate in a particular agency mode during a particular time. For example, during some times, agency module 212 may operate system 200 as its own agent or entity (e.g., as a generic information portal device). At other times, such as when another person may communicate with a person identified by system 200, agency module 212 may operate system 200 as though it were appearing as that other person. In some example embodiments, agency module 212 may present an image, a graphical representation, a textual description, or some other representation of the other person for display to the identified person. In some examples, agency module 212 may operate system 200 as representing an organization (e.g., an enterprise employing the person).

In certain embodiments, one or more of modules 202 in FIG. 2 may represent one or more software applications or programs that, when executed by a computing device, may cause the computing device to perform one or more tasks. For example, and as will be described in greater detail below, one or more of modules 202 may represent modules stored and configured to run on one or more computing devices 302, such as computing devices 302 illustrated in FIG. 3 (e.g., operating as information portal devices or robots of an overall information system). One or more of modules 202 in FIG. 2 may also represent all or portions of one or more special-purpose computers configured to perform one or more tasks.

As illustrated in FIG. 2, example system 200 may also include one or more memory devices, such as memory 240. Memory 240 generally represents any type or form of volatile or non-volatile storage device or medium capable of storing data and/or computer-readable instructions. In one example, memory 240 may store, load, and/or maintain one or more of modules 102. As illustrated in FIG. 2, example system 200 may also include one or more physical processors, such as physical processor 230, that may access and/or modify one or more of modules 202 stored in memory 240. Additionally or alternatively, physical processor 230 may execute one or more of modules 202.

As illustrated in FIG. 2, example system 200 may also include one or more additional elements 220, such as one or more sensors 222, a user interface 224, a communication network interface 226, and/or a mobility component 228. In some example embodiments, sensors 222 may generate sensor data in a vicinity of system 200 for use by identification module 204 to identify a person. Examples of sensors 222 may include, but are not limited to, optical sensors, image sensors, audio sensors, tactile (e.g., fingerprint) sensors, electronic sensors, and so on, as mentioned above.

User interface 224 may present the portion of the personally applicable information for the identified person, as selected by information selection module 208. In some examples, user interface 224 may include a visual display, an audio speaker, and/or other user interface components capable of presenting that information. Also in some examples, user interface 224 may, by audio or visual means, attract the attention of the identified person (e.g., as indicated by identification module 204) in response to identifying the person so that the person may view the personally applicable information to be presented. In some examples, user interface 224 may also receive input from a person (e.g., the person identified by identification module 204), such as by way of a touchscreen, microphone, keyboard, and/or other input components. In some examples, a person may select a particular item of information selected by information selection module 208, and information selection module 208 may use such input to provide more detail regarding the particular item. In other examples, a person may provide input using user interface 224 to direct system 200 to perform other functions described herein in addition to the presentation of personally applicable information.

In some examples, communication network interface 226 may facilitate communication between system 200 and other systems, such as by way of a communication network. For example, communication network interface 226 may access identification information employed by identification module 204 to identify a person based on sensor data (e.g., from sensors 222). In another example, communication network interface 226 may facilitate retrieval of personally applicable information by information access module 206. In addition, communication network interface 226 may access information describing a current context associated with the identified person that may be used by information selection module 208 to select the portion of personally applicable information for presentation (e.g., via user interface 224). In some examples, communication network interface 226 may access information (e.g., map information, information regarding current locations of one or more people, image and/or vocal information representing one or more people) to facilitate the operation of mobility module 210 and agency module 212. In other examples, communication network interface 226 may access other types information, such as by way of a network, to enable operation of system 200, as described herein.

Mobility component 228, in some examples, may provide locomotion (e.g., using electric motors) to enable system 200 to travel from one location to another (e.g., as directed by mobility module 210). Such locomotion may be facilitated using one or more locomotive structures (e.g., wheels, tracks, and/or leglike structures) that may also constitute a portion of mobility component 228.

Mobility module 210 and mobility component 228, possibly with assistance from sensors 222, may be employed to utilize mobility in a variety of ways. For example, system 200 may travel to one or more locations at which people are either currently located, or are expected to be located, to provide personally applicable information to those individuals. In other examples, in conjunction with providing such information, system 200 may provide one or more services, such as leading the identified person to a particular location (e.g., a restroom, a dining area, a meeting room), such as location that is the subject of the personally applicable information. In some examples, system 200 may deliver or retrieve an item f interest to the identified person.

Example system 200 in FIG. 2 may be implemented in a variety of ways. For example, all or a portion of example system 200 may represent portions of example system 300 in FIG. 3. As shown in FIG. 3, system 300 may include multiple computing devices 302 in communication with one or more of an information server 306 and a guidance server 308 via a network 304. In one example, all or a portion of the functionality of modules 202 may be performed by one or more of computing devices 302, information server 306, guidance server 308, and/or any other suitable computing system. As will be described in greater detail below, one or more of modules 202 from FIG. 2, when executed by at least one processor of computing device 302 (e.g., physical processor 230), may enable computing devices 302 to operate in conjunction with information server 306 and/or guidance server 308 to provide personally applicable information by computing devices 302.

Computing device 302 generally represents any type or form of computing device capable of reading computer-executable instructions. In some examples, each computing device 302 operates as an information portal device that presents personally applicable information to one or more people. This information portal device, in some examples, may be stationary (e.g., placed at an easily accessible location) or mobile (e.g., able to move among several places of potential interest, such as within a building or other area). Also in some examples, multiple information portal devices may be stationed throughout a facility, such as a public or corporate building, and may provide personally applicable information that corresponds to that facility (e.g., locations of dining areas, restrooms, and the like). Additional examples of computing device 302 include, without limitation, laptops, tablets, desktops, servers, cellular phones, Personal Digital Assistants (PDAs), multimedia players, embedded systems, wearable devices (e.g., smart watches, smart glasses, etc. art vehicles, so-called Internet-of-Things devices (e.g., smart appliances, etc.), gaming consoles, variations or combinations of one or more of the same, or any other suitable computing device.

In some examples, information server 306 may store, or maintain access to, information that may be personally applicable to one or more people, as described above. In some examples, information server 306 may access such information from other information systems or servers (e.g., email servers, map information servers, news websites, internal enterprise (“intranet”) websites, etc.). Additionally, in some examples, information server 306 may access personal characteristic information (e.g., personal preference information and/or personal historical information) for multiple people, as mentioned earlier. Information server 306, in some examples, may locally store the personal characteristic information, as provided by individuals, and/or from other information sources personally approved by those individuals (e.g., social networking sites, blogs, etc.).

Additional examples of information server 306 and guidance server 308 include, without limitation, storage servers, database servers, application servers, and/or web servers configured to run certain software applications and/or provide various storage, database, and/or web services. Although illustrated as single entities in FIG. 3, information server 306 and guidance server 308 may each include and/or represent a plurality of servers that work and/or operate in conjunction with one another.

Network 304 generally represents any medium or architecture capable of facilitating communication or data transfer. In one example, network 304 may facilitate communication between computing devices 302, information server 306, and guidance server 308. In this example, network 304 may facilitate communication or data transfer using wireless and/or wired connections. Examples of network 304 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, or any other suitable network.

Many other devices or subsystems may be connected to system 200 in FIG. 2 and/or system 300 in FIG. 3. Conversely, all of the components and devices illustrated in FIGS. 2 and 3 need not be present to practice the embodiments described and/or illustrated herein. The devices and subsystems referenced above may also be interconnected in different ways from that shown in FIG. 3. Systems 200 and 300 may also employ any number of software, firmware, and/or hardware configurations. For example, one or more of the example embodiments disclosed herein may be encoded as a computer program (also referred to as computer software, software applications, computer-readable instructions, and/or computer control logic) on a computer-readable medium.

FIG. 4 is a flow diagram of an example method 400 of identifying a person (e.g., by an information portal device) in response to the person signaling the information portal device. At step 410, the information portal device (e.g., using identification module 204) may detect a person signaling to the information portal device based on the captured sensor data (e.g., generated by sensors 222). For example, based on recognition of human gestures (e.g., intentionally making arm or hand motions, exhibiting a facial expression, moving to intercept the information portal device, standing in front of the information portal device, turning to address the information portal device, making audible exclamations (e.g., whistles, introductory phrases, etc.), making physical contact with the information portable device, and the like), identification module 204 may determine that the person making the gesture desires interaction with the information portal device. In other examples, a person may indicate a need for the information portal device by way of an application executing on a smartphone of the person. In yet other examples, a person may hail the information portal device by activating a stationary button or other signaling device, such as may be installed at various places within a building or other facility.

At step 420, in response to detecting the gesturing person, the information portal device (e.g., using identification module 204) may identify the person, such as by way of facial recognition, voice recognition, etc., as described above. In some examples, the information portal device may prioritize identifying a person over others in the vicinity of the information portal device based on that person signaling the information portal device. Also, in examples in which multiple people are signaling the information portal device, the information portal device may prioritize identifying each person based on one or more characteristics, such as a distance between each person and the information portal device (e.g., the closest person to the information portal device may be identified first).

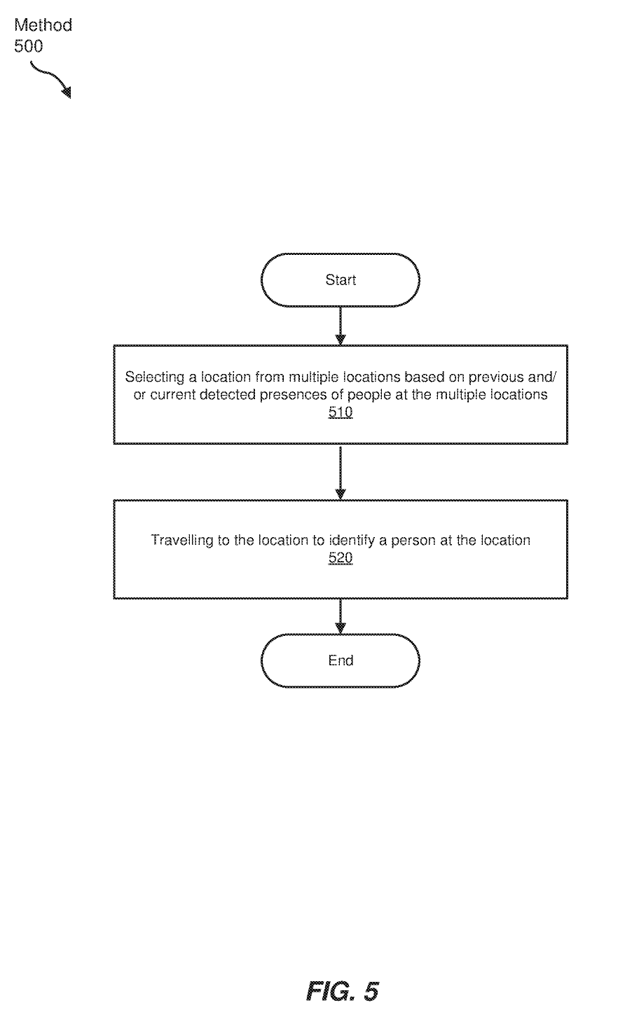

FIG. 5 is a flow diagram of an example method 500 of employing a mobile information portal device to provide personally applicable information at one or more particular locations, such as areas of a facility. At step 510, in some examples, the information portal device or an external system (e.g., guidance server 308) may select a location from multiple locations based on previous and/or current detected presences of people at the multiple locations. For example, the mobile information device or guidance server 308 may select a location at which many people are either currently present or expected to arrive to provide personally applicable information to those people. At step 520, in response to the selection, the mobile information portal device may travel to the location (e.g., using mobility module 210 and mobility component 228) to begin the identification of one or more of the people present at the location. In some examples, system 300 (e.g., using guidance server 308) may dispatch multiple mobile information portal devices to one or more locations based on, for example, the current and/or expected number of people at each of the locations.

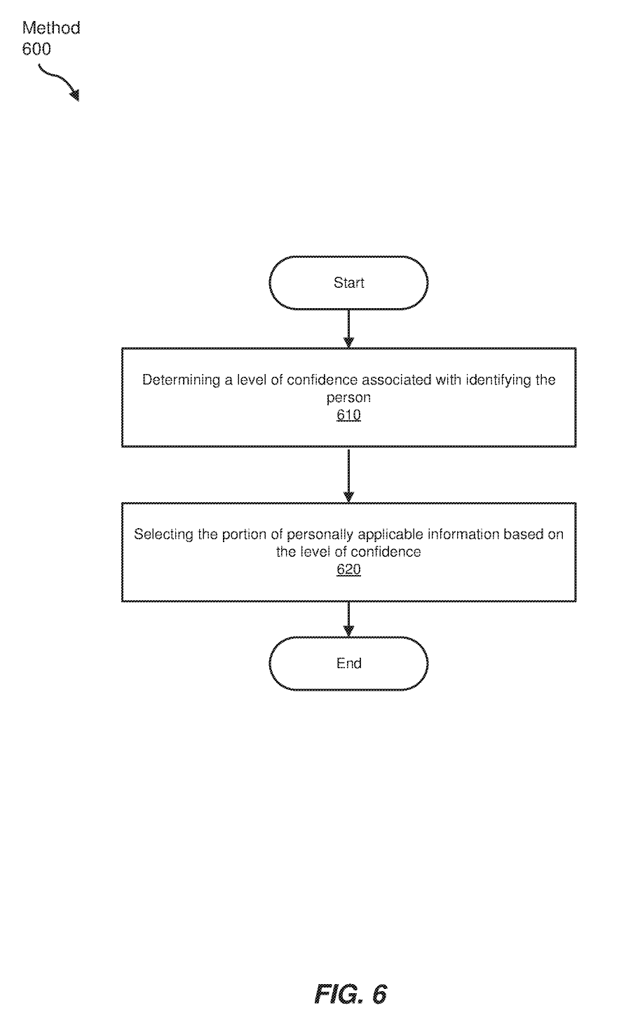

FIG. 6 is a flow diagram of an example method 600 of basing the selection of a portion of the personally applicable information on a level of confidence associated with the identifying of the person. At step 610, in some examples, the information portal device (e.g., using identification module 204) may determine or generate a level of confidence associated with the identifying of the person. For example, the level of confidence may be based on a calculated probability that the identification of the person (e.g., based on the sensor data from sensors 222) is accurate. Such level of confidence, in some examples, may be based on whether different types of identification algorithms or data (e.g., a voice recognition algorithm versus a facial recognition algorithm, or a facial recognition algorithm versus an employee badge image recognition algorithm) agree in identifying the person.

In some examples, each type of identification algorithm or data may be associated with a corresponding level of confidence in the accuracy of the identification. For example, a first identification generated by a voice recognition algorithm may be associated with a first level of confidence, a second identification generated by a facial recognition algorithm may be associated with a second level of confidence, and so on. Moreover, in some embodiments, a combination of the levels of confidence associated with each algorithm may be generated or calculated to produce an overall level of confidence in the identification of the person. For example, an average of the various algorithms, a weighted average of each of the algorithms (e.g., based on a relative importance of each algorithm compared to others), or the like may be used to generate the overall level of confidence in the identification.

In some embodiments, a predetermined order of execution for each type of identification algorithm or associated data may be used to generate a particular level of confidence in the identification. For example, a first type of identification algorithm (e.g., a facial recognition algorithm) may generate an identification of the person and associate that identification with a particular level of confidence that the correct person has been identified. If that level of confidence exceeds a predetermined threshold for that algorithm, the resulting level of confidence may be taken as the overall level of confidence that the identification is correct. If, instead, the level of confidence for that algorithm falls below the associated predetermined threshold, a second type of identification algorithm (e.g., a voice recognition algorithm) may be used to identify the person. If that second algorithm generates an identification for a person, along with a level of confidence associated with that identification that exceeds an associated predetermined threshold for the second algorithm, the identification may be considered correct, and the overall level of confidence associated with that identification may be the level of confidence associated with the second algorithm or a combination (e.g., an average, a weighted average based on a weight associated with each algorithm, or the like) of the levels of confidence associated with the first and second algorithms. If, instead, the level of confidence associated with the identification produced by the second algorithm falls below the threshold associated with the second algorithm, a third identification algorithm or data (e.g., an employee badge image recognition algorithm) may be executed or generated to generate an identification and associated level of confidence in the identification. Any number of identification algorithms or types of identification data may be employed serially in such a manner.

At step 620, the portion of personally applicable information selected, as described above, may be based on a level of confidence that the identification of the person is accurate. For example, information of a more sensitive, private, or classified nature (e.g., bank account balances, medical information, etc.)may be selected only if the level of confidence is extremely high, while information of a slightly less sensitive nature (e.g., nonurgent email messages) may be selected for a moderately high level of confidence. In other examples, average levels of confidence may cause selection of publicly available information (e.g., restroom locations, weather forecasts, and so on.)

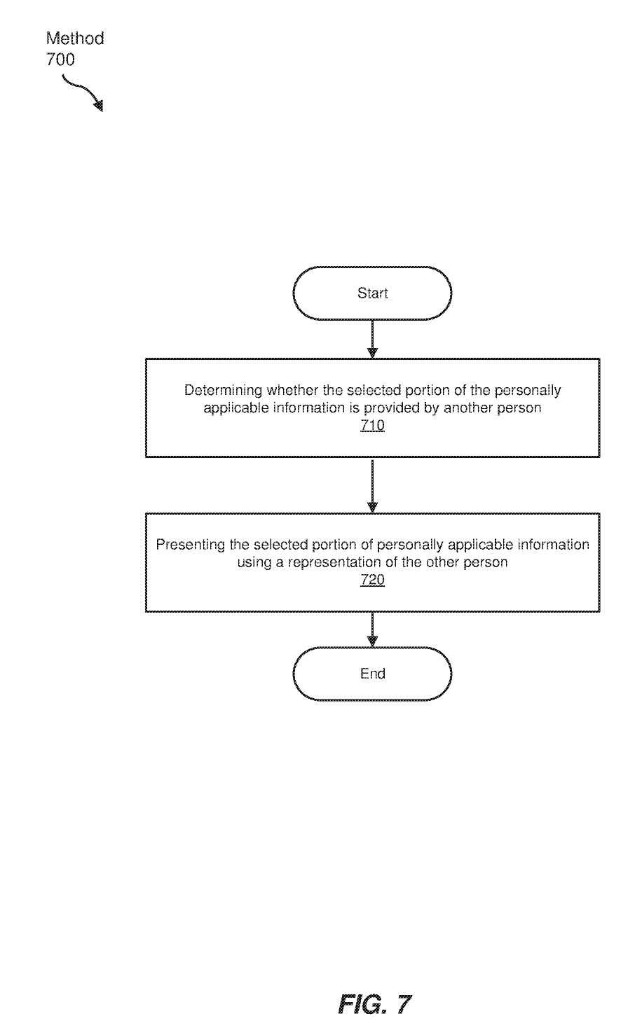

FIG. 7 is a flow diagram of an example method 700 of implementing an agency mode in an information portal device, during which the information portal device may operate as an agent, or project a persona, for another person or entity, as described above. At step 710, in some examples, the information portal device (e.g., using agency module 212) may determine whether the selected portion of the personally applicable information to be presented is provided by another person (e.g., a family member, a coworker, an organization employing the person, etc.). For example, the information may be a communication (an email, an instant message, a voice message, or a video message, whether delayed or live, as well as a two-way-voice or video call) from the other person.

At step 720, based on the selected information being provided by another person, the information portal device (e.g., by agency module 212) may present the information using a representation of the other person. For example, the information portal device (e.g., using user interface 224) may present a still image, moving image, current video image, icon, or textual representation of the other person during the presentation of the information, thus indicating that the information portal device itself is representative of that person. In some examples, at times when the information portal device presents information provided by a particular entity or organization, the information portal device (e.g., by agency module 212) may be representative of a particular person associated with that entity or organization (e.g., an owner, a manager, a celebrity endorser, and the like). At other times, the information portal device, whether presenting information or performing some other task (e.g., delivering an item to the person, leading the person to a particular location of interest, and so on), may not specifically represent any particular person, in some examples.

FIG. 8 is an illustration of portion of an example information portal device 800 for providing personalized context-aware information (e.g., personally applicable information 804). In this example, a display 802 (e.g., operating as at least part of user interface 224) may present one or more portions of personally applicable information 804 (e.g., email messages, calendar items, local points of interest, current weather information, and so forth, possibly in a “dashboard” presentation). One or more sensors 806 (e.g., sensors 222) may be incorporated into information portal device 800 to generate sensor data that may be employed to identify a person in a vicinity of information portion device 800, as discussed above. In some examples, display 802 may be a touchscreen that facilitates user selection of one or more items of personally applicable information 804, such as to obtain greater detail regarding that particular item (e.g., text of an email message, detailed information regarding a calendar item, and so on). In some examples, display 802 may highlight one or more portions of personally applicable information 804 based on context information, such as a particular calendar item with an impending due date, or a recent email message associated with an important subject matter area.

As depicted in FIG. 8, information portal device 800 may include locomotive components (e.g., mobility component 228) (in this example, motor-driven wheels) for providing mobility of the information portal device 800 from one location to another within a building or facility, as described above. In some examples, information portal device 800 may move within a room (e.g., navigating among people) to enable improved detection of a person, or to better position display 802 for presentation of information to a detected person. In some examples, such movement may also help signal to a detected person that information is available for the detected person via display 802. Also in some examples, information portal device 800 may signal the detected person by using visual signals (e.g., flashing a portion of display 802, presenting the name of the detected person using display 802, and so on) or audio signals (e.g., calling the name of the detected person).

As explained above in conjunction with FIGS. 1 through 8, the systems and methods for providing personalized context-aware information described herein may facilitate timely presentation of particularly relevant information to a person, possibly without explicit input (e.g., providing search terms or accessing particular websites) from that person for the type of information desired. In an environment of limited scope or area (e.g., an enterprise campus or building), the particular people that may be present, as well as the types of information applicable to that environment, may be similarly limited, possibly resulting in more efficient identification of individuals and selection of personally applicable information. Use of mobile information portal devices in some examples may enhance the number of opportunities to present such information, as well as possibly provide additional assistance to individuals (e.g., by way of directing individuals, carrying items, etc.).

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

The term “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the sa variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive personally applicable data from a particular person for presentation to a separate identified person, thus causing the physical device (e.g., an information portal device, as described above) to adopt an agency or persona of that particular person during presentation of the personally applicable data. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method comprising:
capturing, by at least one sensor of an information portal device, sensor data in a vicinity of the information portal device;
identifying, by the information portal device and based on the sensor data, a person in the vicinity of the information portal device;
accessing, by a communication network interface of the information portal device, personally applicable information corresponding to the person that has been identified;
selecting, by at least one physical processor, a portion of the personally applicable information based on a current context associated with the person; and
presenting, by a user interface of the information portal device, the selected portion of the personally applicable information.

2. The method of claim 1, wherein the current context comprises at least one of:
a current location of the person; or
a current time at a current location of the person.

3. The method of claim 1, wherein the selecting of the portion of the personally applicable information is further based on personal characteristic information corresponding to the person.

4. The method of claim 3, wherein the personal characteristic information corresponding to the person comprises at least one of:
personal preference information corresponding to the person; or
personal historical information corresponding to the person.

5. The method of claim 1, further comprising detecting, by the information portal device, the person signaling to the information portal device, wherein the step of identifying the person is in response to the step of detecting the person signaling to the information portal device.

6. The method of claim 5, wherein detecting the person signaling to the information portal device comprises detecting at least one of:
a physical gesture performed by the person;
an intentional movement by the person;
a facial expression of the person; or
physical contact by the person with the information portal device.

7. The method of claim 1, further comprising travelling, by the information portal device prior to identifying the person, to a location, wherein the step of identifying the person is performed at the location.

8. The method of claim 7, further comprising selecting, prior to travelling to the location, the location from multiple locations based on previous detected presences of multiple people at the multiple locations.

9. The method of claim 1, wherein the sensor comprises an optical sensor that captures optical data of at least a portion of the person.

10. The method of claim 1, wherein the sensor comprises at least one of:
a tactile sensor that captures a fingerprint image of the person; or
an electronic information sensor that captures digital identification information corresponding to the person.

11. The method of claim 1, wherein the sensor comprises an audio sensor that captures a voice of the person.

12. The method of claim 1, wherein selecting the portion of the personally applicable information is further based on a current priority of the selected portion of the personally applicable information relative to a current priority of other portions of the personally applicable information.

13. The method of claim 12, wherein the current priority of the portion of the personally applicable information is based on a time value associated with the portion of the personally applicable information.

14. The method of claim 1, wherein:
a level of confidence is associated with identifying the person; and
selecting the portion of the personally applicable information is further based on the level of confidence.

15. The method of claim 14, wherein:
identifying the person in the vicinity of the information portal device comprises executing a plurality of identification algorithms;
each identification algorithm of the plurality of identification algorithms generates an associated level of confidence; and
the level of confidence associated with identifying the person is based on a combination of the associated levels of confidence.

16. The method of claim 15, wherein executing the plurality of identification algorithms comprises:
executing a first algorithm of the plurality of identification algorithms to generate an identification of the person and a first associated level of confidence; and
executing at least one additional algorithm of the plurality of identification algorithms in response to the first associated level of confidence falling below a threshold.

17. The method of claim 14, wherein a relatively higher level of confidence is associated with the selected portion of the personally applicable information comprising relatively more sensitive information.

18. The method of claim 1, wherein:
the selected portion of the personally applicable information comprises information provided by another person; and
the presenting of the selected portion of the personally applicable information uses a representation of the other person.

19. A system comprising:
at least one sensor that captures sensor data in a vicinity of the system;
an identification module, stored in memory, that identifies a person in the vicinity of the system based on the sensor data;
an information access module, stored in memory, that accesses personally applicable information corresponding to the person that has been identified;
an information selection module, stored in memory, that selects a portion of the personally applicable information based on a current context associated with the person;
a user interface that presents the selected portion of the personally applicable information; and
at least one physical processor that executes the identification module, the information access module, and the information selection module.

20. A computer-readable medium comprising:
computer-readable instructions that, when executed by at least one processor of a computing device, cause the computing device to:
identify a person in a vicinity of the computing device based on sensor data captured in the vicinity of the computing device;
access personally applicable information corresponding to the person that has been identified; and
select a portion of the personally applicable information based on a current context associated with the person for presentation by a user interface of the computing device.
